(19) United States
(12) Patent Application Publication
(10) Pub. No.: US 2009/0254409 A1
(43) Pub. Date: Oct. 8, 2009

(54) SYSTEM AND METHOD FOR RATING AND PRICING ADVERTISING

(76) Inventor: Leonid Kozhukh, Palo Alto, CA (US)

Correspondence Address: PERKINS COIE LLP, P.O. BOX 1208, SEATTLE, WA, 98111-1208, US

(21) Appl. No.: 12/061,535

(22) Filed: Apr. 2, 2008

(51) Int. Cl. G06Q 10/00

(52) U.S. Cl. 705/10

(57) ABSTRACT

In accordance with techniques disclosed herein, a system and method to set prices for advertising are disclosed. Individuals rate the unit of content by expressing experiences with the content numerically. Purchases of the advertising space alter the pricing of the advertising space to reflect demand for the advertising space. The price may be raised to reflect the current price of the advertising space. A number of views of the unit of content affect the price of the advertising space displaying the unit of content. Where content is not used for a period of time, the non-use may decrease the price of the advertising space.

### BACKGROUND

In web based advertising, advertisers are typically paid to direct customers to a website offering products or services. The advertisers are often paid for a cost per click (CPC) or a cost per milli (CPM). CPM defines a price for one thousand page impressions, where a page impression is generated each time a user views a page, e.g., by loading the page.

Various websites define rating systems which can be used to collect individual end user opinions of user generated content (UGC), advertising as entertainment, as well as other content. Over time numerous user experiences are collected by the ratings. Together, the numerous ratings tend to indicate popularity of content.

For such various types of content, advertisers can purchase space to display the content. Pricing of such advertising space is typically controlled by advertising providers, companies that sell or rent the advertising space. CPM rates and other rates for pricing advertising have not been made available to the public in any transparent fashion. Typically pricing is set behind closed doors and purchasers are left to wastefully spend on advertising without insight into any pricing scheme. The advertising pricing models are illiquid and often represents a significant barrier to entry for small businesses and individuals.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A technique prices advertising space displaying a rated unit of content. Individuals rate the unit of content by expressing experiences with the advertising numerically, such as by selecting a number on a scale, for example, 1-5, 0-100, −5 to +5. Purchases of the advertising space are reflected in the pricing of the advertising space. A number of views of the unit of the rated unit of content affect the price of the advertising space displaying the content. Where content is not viewed for a period of time, the lack of interest may decrease the price.

In a system operating in accordance with the technique described above, a content provider shares content with users while a rating engine captures the user experience with the content. Pricing information incorporates rating, views, purchases, and any known or convenient factors to set a price for advertisers. The pricing changes fluidly with value of the advertising space transparently to the advertiser.

In a method implementing the technique discussed above, content is transmitted to a user, a rating is received, a rated level is calculated incorporating the rating, and a price is calculated incorporating a number of views of the content and the rating of the content. The method may also consider the demand for the advertising space by advertisers, such as by considering the price that the advertisers pay.

### BRIEF DESCRIPTION OF THE DRAWINGS

FIG. 1 depicts an example of a system for pricing advertising space displaying content.

FIG. 2 is a block diagram including modules of an example of a system for capturing a user's experience for incorporation in a price.

FIG. 3 is a flowchart of a method for valuing advertising space.

FIG. 4 depicts an example of a system incorporating auctioning into advertising pricing.

FIG. 5 is a flowchart of an example of a method for increasing and decreasing a price of advertising space displaying a unit of content.

FIG. 6 is a high-level block diagram showing an example of the architecture of a processing system that can be representative of any of the processing systems discussed herein, such as system for pricing advertising space.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

In accordance with the techniques introduced above, advertising space is priced according to a number of factors. Among other things, rating of a unit of content displayed in an advertising space, views of the unit of content, demand for the advertising space, and elapsed time can affect the price of the advertising space.

As used herein, a “user” is an individual able to experience content, such as by watching videos or listening to music. As used herein, an “advertiser” is a company or individual desiring to purchase a unit of advertising space to promote and display content.

As used herein, “content” is a video, a picture or any other media. Content is typically provided in a web interface, such as a web browser executing on a computing device, and can be displayed in advertising space purchased by an advertiser.

As used herein, “advertising space,” or “advertising space displaying content” is used to mean a visible space including an image, video, thumbnail or other display of content.

As used herein, “rating” is a manner of scoring a user's experience with content. A rating could be a number between a lower bound and a higher bound indicating an average of two or more user's ratings of a unit of content. Any known or convenient scale, e.g. 1 to 5, 0 to 100, −5 to +5 etc. can be used. The rating can be used to identify preferable content. For example, a video rated “7” would be considered more enjoyable than a video rated “5.”

As used herein, a “comment” is a user statement discussing a unit of content.

As used herein, an “opinion” is a comment tied to a rating of a unit of content, e.g., a numerical value indicating a user's like or dislike of the unit of content. The tie can be by internet protocol (IP) address, a cookie, a registration system, or any known or convenient manner of relating the user's numerical value to the content.

As used herein, “user engagement,” or “engagement” is defined as one or more values selected from a number of views of a unit of content, a rated level, a click through rate, a number of comments, a number of unique viewers, and any known or convenient numerical measure of user engagement.

As used herein “demand” is defined as historical purchasing of a unit of advertising space by one or more advertisers at various prices.

As used herein an “engine” includes a processor and a memory. The memory stores instructions for execution by the processor to perform a task of the engine. In a non-limiting example, a user interface engine could be a computing system tasked with receiving user input via a human interface device and displaying information responsibly to the user.

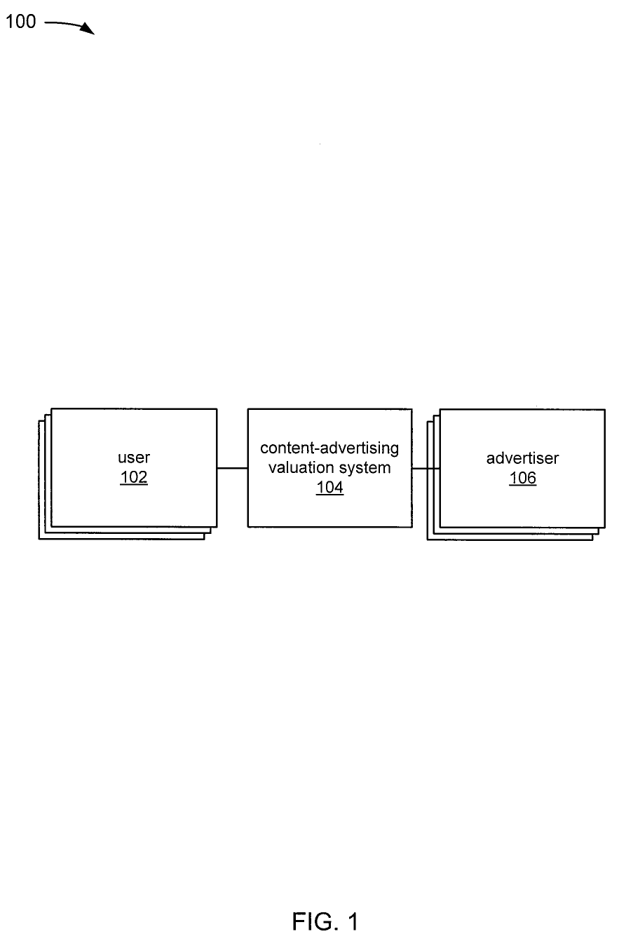

FIG. 1 depicts an example of a system 100 for pricing advertising space displaying content. FIG. 1 includes user 102, content-advertising valuation system 104, and advertiser 106.

User 102 can be an individual with a computing device having network access for transmitting and receiving data, such as by accessing the internet. There are typically one or more users in addition to user 102. User 102 has an interest in content, such as watching videos, viewing pictures, listening to music, or media. At times, user 102 is willing to rate content relative to other content, such as by assigning a numerical value, e.g. 1 to 10 for the content.

Content-advertising valuation system 104 can be one or more computing systems executing one or more processes directed to pricing content. The processes executed by the content-advertising valuation system 104 may be executed on one or more hardware units and the hardware units can be networked together. The content-advertising valuation system includes a number of modules, and the modules are discussed in detail below.

Advertiser 106 can be an individual or company with a computing device having network access for transmitting and receiving data, such as by accessing the internet. There are typically one or more advertisers in addition to advertiser 106. The advertiser 106 is interested in purchasing advertising space to display content.

In the example of FIG. 1, in operation, the user 102 views content provided by the content-advertising valuation system, and assigns ratings to the content. The content advertising valuation system 104 assigns a price to advertising space displaying the content, and updates an interface visible to the advertiser 106. Numerous factors can influence the price of advertising space, such as a rating provided by the user 102, a number of views of the unit of content by the user 102 and other users, as well as purchasing demand for the advertising space by the advertiser 106 and other advertisers.

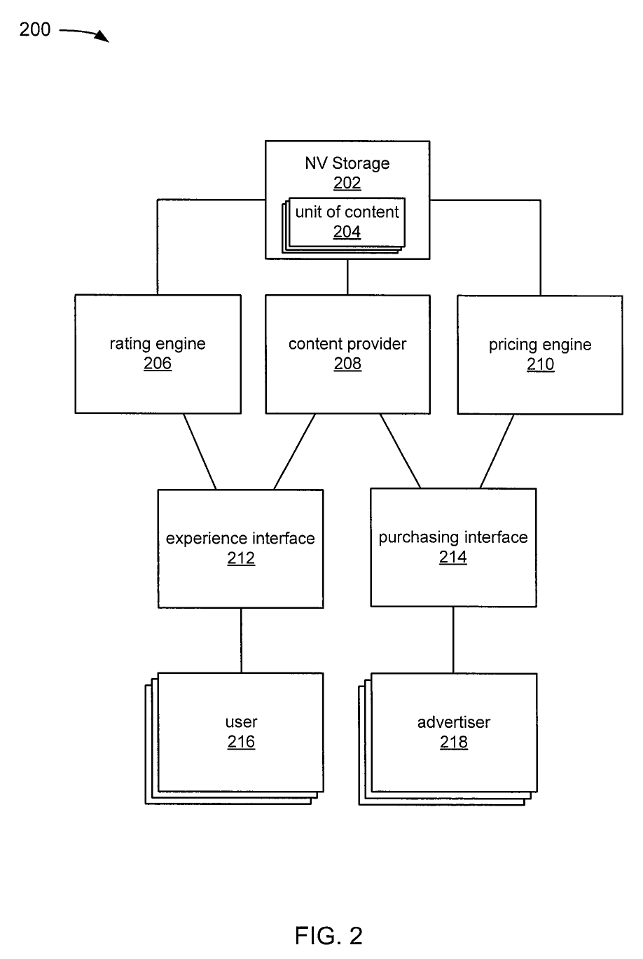

FIG. 2 is a block diagram 200 including modules of an example of a system for capturing a user's experience for incorporation in a price. FIG. 2 includes non-volatile (NV) storage 202, which includes unit of content 204, rating engine 206, content provider 208, pricing engine 210, experience interface 212, purchasing interface 214, user 216, and advertiser 218. The various modules can operate on one or more hardware units, and the hardware units can be connected by one or more networks. The user 216 and the advertiser 218 are as described above in reference to FIG. 1.

In the example of FIG. 2, the non-volatile storage 202 can be a mass storage device, or one or more mass storage devices. The mass storage devices could be networked storage, such as is provided by a storage server over a network. The NV Storage 202 can store one or more units of content and data associated with the units of content such as a number of views of the unit of content, a rating associated with the unit of content, recent purchases and prices of units of content, historical demand for content, and any known or convenient information regarding the unit of content.

In the example of FIG. 2, the rating engine 206 implements a function to produce a rating from a plurality of ratings such as by averaging, weighting, or otherwise combining the ratings of a unit of content to produce a single rating for the unit of content. In a non-limiting example, users are allowed to rate a unit of content once, and their ratings are averaged.

In the example of FIG. 2, the content provider 208 transmits content to a user via an interface. The content provider 208 retrieves a unit of content and transmits the content to a user. A user receives the content from the content provider 208 and views the content.

In the example of FIG. 2, the pricing engine 210 determines a price for advertising space displaying a unit of content considering, e.g. unit of content, a rating associated with the unit of content, recent purchases and prices of units of content. The price is a lowest price; additional factors such as demand for the advertising space can increase the price. Each thousand views is assigned an incremental value so that a unit's content would increased by, e.g. 20 cents, for each 1000 views. In a non-limiting example, a price was 1.00 including all pricing factors at 1000 views, and was increased by 20 cents when 2000 views were reached, and then increased by an additional 20 cents to 1.40 when 3000 views were reached.

In the example of FIG. 2, the experience interface 212 can be a web interface displaying links to content as well as advertising. The experience interface 212 can display content in space purchased by advertisers. The experience interface 212 can also allow searching for content.

In the example of FIG. 2, the purchasing interface 214 displays a link to content along with a price for advertising space displaying content. Several specific advertising locations on the interface can be held constant and associated with analytics related to demand for the specific advertising spaces. Content displayed in the advertising space can change over time. For example, a first, second and third advertising space can be associated, in order, with the first second and third highest value content. Analytics can also be displayed showing such information as trends in viewing of the content. Advertisers can purchase the advertising space using the purchasing interface 214 at the price displayed. Each advertising space can be auctioned to a highest bidder. It can be possible to have any number of advertising spaces, for example, 20 advertising spaces could be available on a first page. However, n different advertising spaces can be displayed using multiple pages at a rate of, e.g., 15 spaces per page.

In the example of FIG. 2, in operation, the user 216 views links to content through the experience interface 212 and selects the unit of content 204 to view. The content provider 208 transmits the unit of content 204 to the user 216. The user 216 views the unit of content 204 and determines a rating for the unit of content 204, such as by providing a 1 for poor content or a 5 for excellent content. The rating is transmitted to the rating engine 206 which incorporates the user rating into existing ratings. If the unit of content 204 is new or otherwise does not have a rating, the rating engine 206 establishes a rating for the content as the rating provided by the user 216. The rating is stored in the NV storage 202 in association with the unit of content 204. The pricing engine 210 uses the rating along with a number of views of the content to establish a price for advertising space displaying the unit of content. The price is displayed in the purchasing interface 214 to advertiser 218 who purchases the advertising space displaying the unit of content 204. The purchased advertising space then displays a unit of content provided by the advertiser 218. A user other than user 216 views the experience interface 212 including the ad provided by advertiser 218.

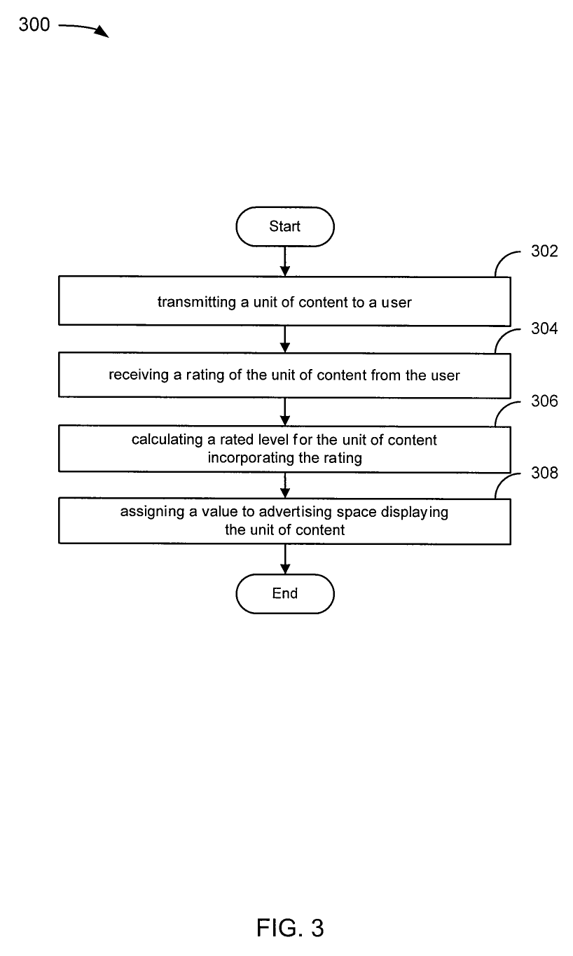

FIG. 3 is a flowchart 300 of a method for valuing advertising space. The method is organized as a sequence of modules in the flowchart 300. However, it should be understood that these and modules associated with other methods described herein may be reordered for parallel execution or into different sequences of modules.

In the example of FIG. 3, the flowchart 300 starts at module 302 with transmitting a unit of content to a user. A user may have requested the unit of content. In a non-limiting example, the content is a movie or a song that the user watches or listens to. While viewing the content, the user typically develops an opinion of the content. The transmission can conclude with asking the user to express the opinion as a number, such as a value of 1-5, however, the scale could be any value, e.g. 0-7, 1-100, −5 to +5.

In the example of FIG. 3, the flowchart continues to module 304 with receiving a rating of the unit of content from the user. The rating can be expressed as a number incorporating and articulating the user's opinion of the content.

In the example of FIG. 3, the flowchart continues to module 306 with calculating a rated level for the unit of content incorporating the rating. Zero or more prior values could have been taken. If no prior values have been received, the value received at module 304 can become the rated level. Alternatively, the rating could be averaged in with the other ratings to produce the rated level. In some cases, weighting could be applied to various ratings, such as to add value to ratings from users, or to decrease ratings from users.

In the example of FIG. 3, the flowchart continues to module 308 with assigning a value to advertising space displaying the unit of content. The value can be calculated to define a lowest price incorporating a value for a number of views of the content, and a rating for the content. Demand for the advertising space can be a factor as well. Additional factors such as demand for the advertising space can increase the price. Having assigned a value to advertising space displaying the unit of content, the flowchart terminates.

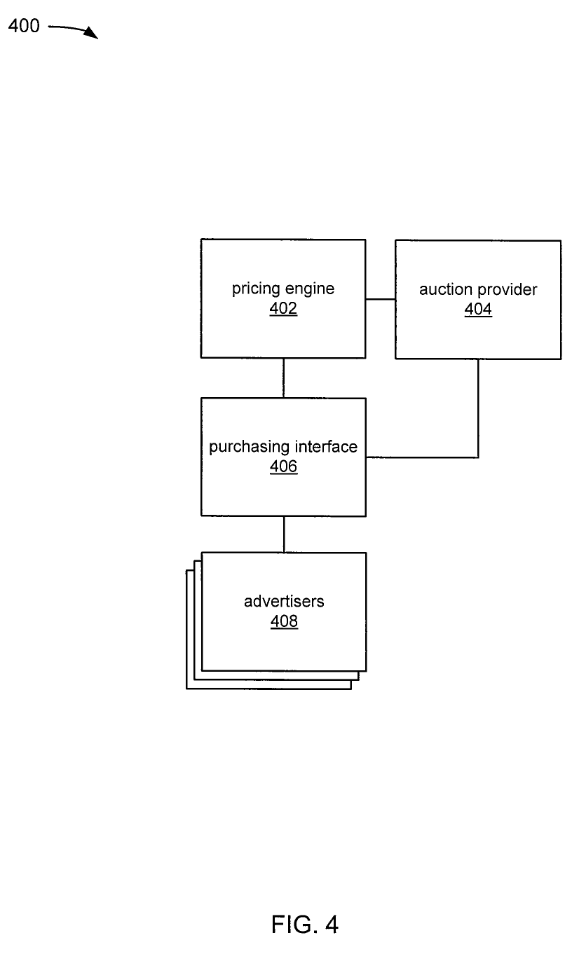

FIG. 4 depicts an example of a system 400 incorporating auctioning into advertising pricing. FIG. 4 includes pricing engine 402, auction provider 404, purchasing interface 406, and advertiser 408. In the example of FIG. 4, pricing engine 402 and purchasing interface 406 are as described above.

Advertisers 408 are two or more advertisers generating demand for advertising space. Advertisers 408 may, at times, compete with each other for advertising space by offering to pay various amounts for advertising space.

Auction provider 404 adjusts the price of advertising space. The auction provider 404 can increase the price of advertising space in response to a purchase. By increasing the price of advertising space in response to purchases of the advertising space, the auction provider 404 factors demand into the price. The auction factor is reflected the increased price displayed to future purchasers of the advertising space.

In the example of FIG. 4, in operation, an advertiser of the advertisers 408 purchases a unit of content priced by the pricing engine 402 based on a price reflected by the purchasing interface 406. The purchase price is forwarded to the auction provider 404 which increases the price of the advertising space. Subsequent purchases are controlled by the pricing engine 402 such as by requiring a step increase in price, e.g. a number of dollars or cents, such as $1, or $2.50, or 65 cents above the last price for a subsequent purchaser to purchase the advertising space. The purchasing interface reflects the increased price to advertisers 408 along with the step increase in pricing required to purchase the advertising space.

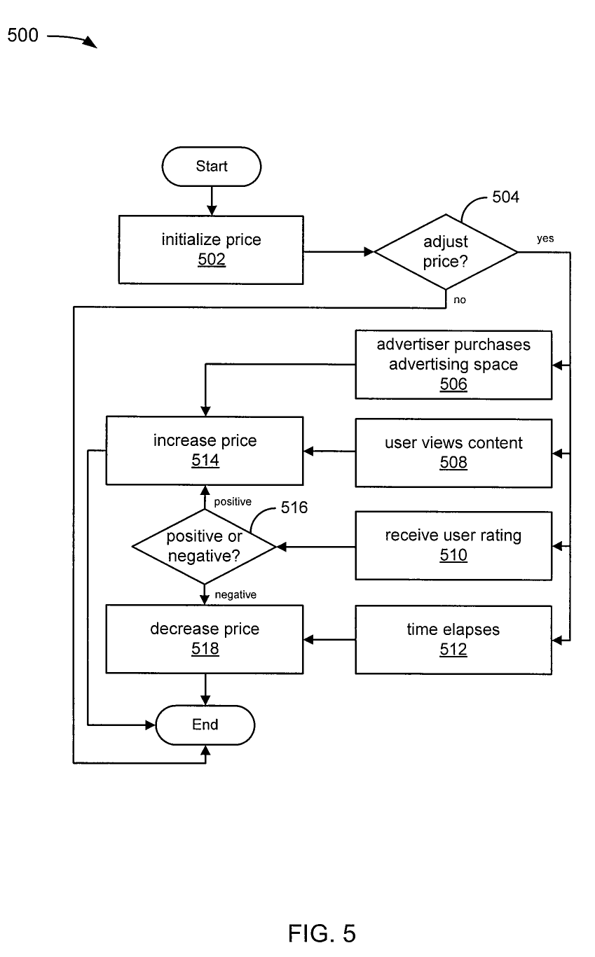

FIG. 5 is a flowchart 500 of an example of method for increasing and decreasing a price of advertising space displaying a unit of content. The method is organized as a sequence of modules in the flowchart 500. However, it should be understood that these and modules associated with other methods described herein may be reordered for parallel execution or into different sequences of modules.

In the example of FIG. 5, the flowchart starts at module 502 with initializing a price for advertising space displaying content. A fixed initialization price can be used, or alternatively, the price could be initialized by setting the price by factors such as a genre of content associated with advertising space, and advertising associated with similar content; where a price has already been set, the price is not re-initialized.

In the example of FIG. 5, the flowchart continues to module 504 with deciding: adjust the price? Where an advertiser has purchased advertising space, a user views content, a rating is received or time elapses, the decision is yes. Alternatively, the decision is no, and the flowchart terminates having not adjusted the price.

In the example of FIG. 5, where the decision at module 504 is yes, the flowchart continues to any one of module 506, 508, 510, or 512 depending on whether an advertiser has purchased space, a user has viewed content, a rating has been received or time elapses.

In the example of FIG. 5, where an advertiser purchases advertising space, the flowchart continues to module 506, the flowchart continues to module 514 with increasing the price of advertising. The increase may be one factor of many factors, and can directly increase the price at each purchase so as to create a marketplace responding to demand for the advertising space.

In the example of FIG. 5, where a user views content, the flowchart continues to module 514 with increasing price. The increase in price can be a factor of many factors. This particular increase in price factor can be scaled to become marginal because many users will view the content. In a non-limiting example, 1000 user views could be required prior to changing the price factor associated with the viewing of content.

In the example of FIG. 5, where a user rating is received, the flowchart continues to module 516 with deciding: positive or negative? If the decision at module 516 is positive, then the flowchart continues to module 514 with increasing the price. The increase may be one factor of many factors. Where users like content, they are apt to provide positive feedback about the content. As such, the price of advertising space is increased for positive feedback or decreased for negative feedback. The value associated with additional feedback could be averaged so that where many users have rated the content, the price of associated advertising space does not rapidly increase or decrease. Additionally, older ratings may be disregarded over time so as to keep the rating current.

In the example of FIG. 5, where time elapses, the flowchart continues to module 518 with decreasing price. The decrease may be slight, but count as a factor such that over time, the price will decay if the advertising space displaying the content is not purchased, the content is not viewed, and no positive user ratings are received.

In the example of FIG. 5, from either module 514 or module 518, the flowchart terminates having increased or decreased the price.

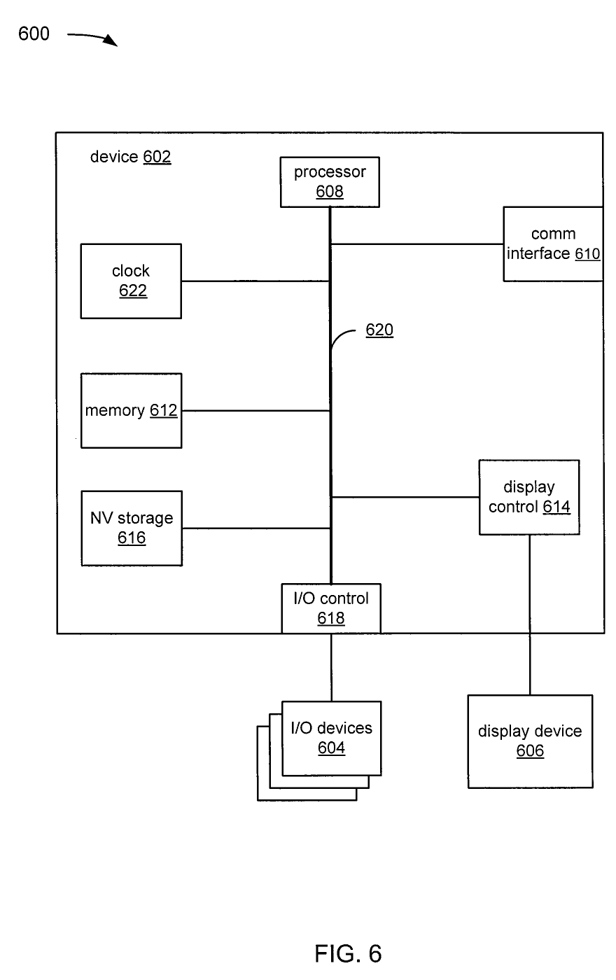

FIG. 6 is a high-level block diagram showing an example of the architecture of a processing system that can be representative of any of the processing systems discussed herein, such as system for pricing advertising space. The system 600 may be a conventional computer system that can be used as a client computer system, such as a wireless client or a workstation, or a server computer system. The system 600 includes a device 602, I/O devices 604, and a display device 606. The device 602 includes a processor 608, a communications interface 610, memory 612, display controller 614, non-volatile storage 616, I/O controller 618, clock 622. The device 602 may be coupled to or include the I/O devices 604 and the display device 606.

The device 602 interfaces to external systems through the communications interface 610, which may include a modem or network interface. It will be appreciated that the communications interface 610 can be considered to be part of the system 600 or a part of the device 602. The communications interface 610 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 608 may be, for example, a conventional microprocessor such as an Intel Pentium microprocessor or Motorola power PC microprocessor. The memory 612 is coupled to the processor 608 by a bus 620. The memory 612 can be Dynamic Random Access Memory (DRAM) and can also include Static RAM (SRAM). The bus 620 couples the processor 608 to the memory 612, also to the non-volatile storage 616, to the display controller 614, and to the I/O controller 618.

The I/O devices 604 can include a keyboard, disk drives, printers, a scanner, and other input and output devices, including a mouse or other pointing device. The display controller 614 may control in the conventional manner a display on the display device 606, which can be, for example, a cathode ray tube (CRT) or liquid crystal display (LCD). The display controller 614 and the I/O controller 618 can be implemented with conventional well known technology.

The non-volatile storage 616 is often a magnetic hard disk, flash memory, an optical disk, or another form of storage for large amounts of data. Some of this data is often written, by a direct memory access process, into memory 612 during execution of software in the device 602. One of skill in the art will immediately recognize that the terms “machine-readable medium” or “computer-readable medium” includes any type of storage device that is accessible by the processor 608.

Clock 622 can be any kind of oscillating circuit creating an electrical signal with a precise frequency. In a non-limiting example, clock 622 could be a crystal oscillator using the mechanical resonance of vibrating crystal to generate the electrical signal.

The system 600 is one example of many possible computer systems which have different architectures. For example, personal computers based on an Intel microprocessor often have multiple buses, one of which can be an I/O bus for the peripherals and one that directly connects the processor 608 and the memory 612 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 612 for execution by the processor 608. A Web TV system, which is known in the art, is also considered to be a computer system, but it may lack some of the features shown in FIG. 6, such as certain input or output devices. A typical computer system will usually include at least a processor, memory, and a bus coupling the memory to the processor.

In addition, the system 600 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 616 and causes the processor 608 to execute the various acts required by the operating system to input and output data and to store data in memory, including storing files on the non-volatile storage 616.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system comprising:
a non-volatile storage coupled to the processor including a unit of content viewed zero or more times;
a content provider coupled to the non-volatile storage;
a rating engine coupled to the non-volatile storage; and
a pricing engine coupled to the non-volatile storage;
wherein in operation,
the content provider transmits the unit of content to a user;
the rating engine receives a rating of the unit of content from the user;
the rating engine calculates a rated level for the unit of content incorporating the rating; and
the pricing engine assigns a price to advertising space displaying the unit of content based on user engagement.

2. The system of claim 1 wherein user engagement is determined by a number of views of the unit of content,

3. The system of claim 1 wherein user engagement is determined by valuing the rated level of the unit of content.

4. The system of claim 1 wherein user engagement is determined by a click through rate.

5. The system of claim 1 wherein user engagement is determined by a number of comments.

6. The system of claim 1 wherein user engagement is determined by a number of unique viewers.

7. The system of claim 1 further comprising an auction provider changing the price of the advertising space to reflect a purchase of the advertising space.

8. The system of claim 1 wherein the price is increased in response to the user viewing the unit of content.

9. The system of claim 1 wherein the price is decreased in response to passing of a unit of time.

10. The system of claim 1 wherein the price is increased in response to receiving a comment on the unit of content from the user.

11. A method comprising:
transmitting a unit of content to a user;
receiving a rating of the unit of content from the user;
calculating a rated level for the unit of content incorporating the rating; and
assigning a value to advertising space displaying the unit of content including one or more values for user engagement.

12. The method of claim 11 wherein user engagement is determined by a number of views of the unit of content.

13. The method of claim 11 wherein user engagement is determined by valuing the rated level of the unit of content.

14. The method of claim 11 wherein user engagement is determined by a click through rate.

15. The method of claim 11 wherein user engagement is determined by a number of comments.

16. The method of claim 11 wherein user engagement is determined by a number of unique viewers.

17. The method of claim 11 further comprising reflecting the current purchase price of the advertising space in response to a purchase of the advertising space by an advertiser.

18. The method of claim 11 further comprising increasing the value of the advertising space in response to the user viewing the unit of content.

19. The method of claim 11 further comprising decreasing the value of the advertising space in response to passing of a unit of time.

20. The method of claim 11 further comprising increasing the value of the advertising space in response to receiving a positive user opinion of the unit of content.

21. The method of claim 11 further comprising decreasing the value of the advertising space in response to receiving a negative user opinion of the unit of content.

22. The method of claim 11 further comprising increasing the value of advertising space in response to receiving a comment on the unit of content.

23. A method of pricing a unit of content, the method comprising:
receiving a user request for a unit of content that has been viewed by a number of other users, wherein a price for advertising space displaying the unit of content is specified by valuing the number of times that the unit of content has been viewed in increments of thousands of views for each increase of price, and valuing the content by averaging one or more user ratings of the unit of content;
receiving a new rating of the unit of content from the user and re-pricing the unit of content by averaging the new rating with the previous ratings to value the price of the advertising space;
receiving a purchase of advertising space from an advertiser and increasing the price of the advertising space by adding value associated with the demand for the advertising space inferred from the purchase price of the advertising space; and
decreasing the price to account for passage of time associated between a previous valuation of the advertising space and the current time.
